(19) United States
(12) Patent Application Publication
(10) Pub. No.: US 2023/0272250 A1
(43) Pub. Date: Aug. 31, 2023

(54) Ternary Composite Conductive Adhesive and Preparation Method therefor, Slurry and Lithium Battery

(71) Applicant: FULLYMAX BATTERY CO., LTD., Huizhou (CN)

(72) Inventors: Jianxiang DENG, Huizhou (CN); Changhao LIU, Huizhou (CN)

(73) Assignee: FULLYMAX BATTERY CO., LTD., Huizhou (CN)

(21) Appl. No.: 18/314,829

(22) Filed: May 10, 2023

Related U.S. Application Data
(63) Continuation of application No. PCT/CN2021/109413, filed on Jul. 29, 2021.

(30) Foreign Application Priority Data
Jun. 29, 2021 (CN) 202110732371.9

(51) Int. Cl. C09J 109/06; C09J 133/08; C08K 3/04; C09J 11/04; C08K 7/18; C09J 127/16

(52) U.S. Cl. CPC C09J 109/06; C09J 133/08; C08K 3/041; C09J 11/04; C08K 7/18; C09J 127/16; C08K 2201/001; H01M 4/625

(57) ABSTRACT

A ternary composite conductive adhesive includes following items: binder, solvent, conductive agent. The conductive agent includes conductive spherical node substance, conductive fiber transition substance and tubular conductive substance.

### TECHNICAL FIELD

This invention involves in a ternary composite conductive adhesive and its preparation method, slurry and lithium battery.

### BACKGROUND TECHNOLOGY

Conductive agent, as an important part of battery slurry, plays a role in assisting electronics to move between cathode and anode to achieve taking off or embedding of lithium ion. Conductive agent is critical to energy density, battery rate and cycling efficiency. Therefore, the key is to choose appropriate conductive agent to acquire high energy density, long cycle life and high battery rate for lithium batteries.

Currently, main issues found in the use of conductive agent in lithium-ion batteries are following: (1) conductive agent particles are small, they are usually dozens nanometer which leads to poor dispersion, complicated dispersion process. Usually, attentions shall be not only given to mechanical operations, but also to dispersion procedure, for example, the order issue of exclusive dispersion agent and conductive agent for each time for different quantity; (2) conductivity of conductive agent is not high enough. Currently, increasing conductivity is to add metal powder content in conductive agent. However, adding metal powder content will not only increase costs sharply, but also reduce mechanical performance of conductive agent, which is not beneficial to the application of conductive agent.

### SUMMARY OF THE INVENTION

This invention purpose is to overcome shortages in current technologies and to provide one category of Ternary composite conductive adhesive and its preparation method, slurry and lithium battery with better dispersity and high conductivity. One Ternary composite conductive adhesive includes following ingredients:
Binder;
Solvent; and
Conductive agent which includes conductive spherical node substance, conductive fiber transition substance and tubular conductive substance.

One type ternary composite conductive adhesive preparation method is used to make ternary composite conductive adhesive in any implemented case above. The preparation method for above mentioned ternary composite conductive adhesive includes following steps:
Mix binding element and solvent for first mixing, it is obtained gel-containing solvent;
Add conductive tubular substance to above mentioned gel-containing solvent to mix for secondary mixing treatment;
Add conductive fiber transition substance to above mentioned gel-containing solvent after secondary mixing treatment for third mixing treatment; and
Add conductive spherical node substance to above mentioned gel-containing solvent after third mixing treatment for forth mixing treatment.

The present application further provides a slurry including mixed active substance and ternary composite conductive adhesive by the above-mentioned preparation method.

The present application further provides a battery including the above-mentioned slurry.

The details of one or more implemented cases of this invention are put forward in following attached figures and descriptions. Other characteristics, purposes and advantages of this invention can be apparently observed from instructions, attached figures and right claims.

### INSTRUCTIONS FOR ATTACHED FIGURES

It is to clearly explain implemented cases of this invention or technical solutions in current technologies. A brief introduction to attached figures that are needed in implemented cases or technical description will be made as below. Apparently, attached figures are only parts of implemented cases. For ordinary technicians in the field, they can acquire attached figures for other implemented cases based on these figures without making creative efforts.

FIG. 1 is a flow diagram of preparation method of Ternary composite conductive adhesive for implementation of the invention; and

FIG. 2 is a discharge curve at different discharge rate of lithium battery in implementation embodiment 4.

### DETAILED DESCRIPTION

In order to understand this invention easily, full description is made for this invention in accordance with related attached figures as references. The attached figure provides best implementation way of this invention. However, the invention can be achieved by many different forms, it's not limited to the implementation way described in this file. On the contrary, the purpose of providing these implementation ways is to promote deep and full understanding of public contents of the invention.

Unless there is another definition, all technologies and scientific terms used in this file have the same meanings as understanding meaning of technicians working in this field related to the invention. Terms used in this file of the instruction are only for purpose of describing concrete implementation, they are not for limiting the invention. Terminologies used in this file “and/or” include random and all combination of one or more related listed projects.

One Ternary composite conductive adhesive in an implemented case includes: binding element, solvent, conductive agent. And conductive agent includes conductive spherical node substance, conductive fiber transition substance and tubular conductive substance.

Among the Ternary composite conductive adhesives, the outer shape of tubular conductive substance is like a tube, namely the tubular conductive substance is conductive substance with tubular structure, tubular conductive substance with tubular structure has good electron conduction capacity and it can speed up electron conduction. However, if tubular conductive substance is used with large quantity, the tubular conductive substance with tubular structure will gather easily, which will affect conductivity of lithium battery slurry and energy density of lithium battery; If tubular conductive substance is used with little quantity, the low contact between transition electron in slurry containing Ternary composite conductive adhesive and lithium-ion embedded in slurry will reduce conductivity of slurry containing Ternary composite conductive adhesive, which will further make tubular conductive substance to be repeatedly matched for use with conductive spherical node substance and conductive fiber transition substance respectively to reduce use quantity of conductive substance with tubular structure and add contact points between transition electrons in slurry containing Ternary composite conductive adhesive and lithium-ion embedded in slurry. Among them, the outer shape of conductive spherical node substance is like a ball, namely conductive spherical node substance is conductive substance with ball structure, which adds density degree of conductive substance distribution, provides more contact points for lithium-ion in slurry containing Ternary composite conductive adhesive. The outer shape of conductive fiber transition substance is like fiber, namely conductive fiber transition substance is conductive substance with fiber structure. Conductive substance with fiber structure is relatively soft and it can connect conductive substance with tubular structure to conductive spherical node substance, which can help to transit electrons quickly in slurry containing Ternary composite conductive adhesive and boost the capacity of taking off and embedding of lithium-ion embedded in slurry containing Ternary composite conductive adhesive. That adopts repeated matching use of conductive spherical node substance, conductive fiber transition substance and tubular conductive substance, which further improves conductivity of Ternary composite conductive adhesive. Furthermore, use binder and solvent to disperse conductive agent. Solvent provides enough dispersing space for conductive agent, and binder improves viscosity of solvent, which avoids further sedimentation and dispersity of conductive agent is reduced after conductive agent is dispersed in solvent, which can effectively boost dispersing stability of conductive agent.

It is necessary to point out that as the outer shape of tubular conductive substance is similar to a tube, namely the tubular conductive substance is conductive substance with tubular structure, tubular conductive substance with tubular structure has good electron conduction capacity and it can speed up electron transition. Therefore, conductive agent is chosen as tubular conductive substance in order to improve conductivity of Ternary composite conductive adhesive in the applied Ternary composite conductive adhesive. But the outer shape of tubular conductive substance makes it difficult for tubular conductive substance to disperse and easy to gather so that use quantity is limited for tubular conductive substance. Nevertheless, if there is small usage quantity of tubular conductive substance, the outer shape of tubular conductive substance will make the distribution of tubular conductive substance in slurry sparse so that more contact points for electron transition can't be provided for lithium-ion embedded in slurry, which will lead to bad capacity of taking off and embedding of lithium-ion embedded in slurry, and conductivity of slurry and cycle performance of lithium battery will be affected; In addition, if add dispersing agent to conductive agent to increase usage of tubular conductive substance, then the usage of dispersing agent will reduce the content of active substance and further reduce energy density of lithium battery. And the usage of dispersing agent will increase the possibility of side effects of lithium battery, which will further have impact on use safety of lithium battery. Based on above-mentioned issues, tubular conductive substance, conductive spherical node substance and conductive fiber transition substance will be compound for use in the applied Ternary composite conductive adhesive, which will make tubular conductive substance, conductive spherical node substance and conductive fiber transition substance improve performance of Ternary composite conductive adhesive respectively, and whole compound can also improve performance of Ternary composite conductive adhesive. Among them, the outer shape of conductive spherical node substance is like a ball, namely conductive spherical node substance is conductive substance with spherical structure. Conductive substance with spherical structure increase boosts the distribution density degree of conductive substance, which provides more electron transition contact points for lithium-ion in slurry containing Ternary composite conductive adhesive. The outer shape of conductive fiber transition substance is like fiber, namely conductive fiber transition substance is conductive substance with fiber structure which is soft and can connect conductive substance with tubular structure and conductive spherical node substance, which can achieve quick transition of electrons in slurry containing Ternary composite conductive adhesive and improve capacity of taking off and embedding of lithium-ion embedded in slurry containing Ternary composite conductive adhesive, namely adopting conductive spherical node substance, conductive fiber transition substance and tubular conductive substance for compound use, which effectively improves conductivity of Ternary composite conductive adhesive.

It is also necessary to point out that only mutual contacting of conductive substance can achieve electron transition. If only conductive spherical node substance is used to transit electrons, then it shall make sure usage quantity of conductive spherical node substance is big, and connect adjacent conductive spherical node substances to achieve electron transition and there may be circuity transition phenomenon, which will lead to low energy density of lithium battery and bad conductivity of slurry.

In addition, the outer shape of conductive fiber transition substance is like a fiber, namely conductive fiber transition substance is conductive substance with fiber structure, the fiber shape of conductive fiber transition substance makes it difficult for conductive fiber transition substance to disperse and easy to gather, which leads to limit of usage quantity for conductive fiber transition substance. If the usage quantity of conductive fiber transition substance is little, the fiber shape of conductive fiber transition substance will make tubular conductive substance' distribution in slurry dispersing and can't provide more electron transition contact points for lithium-ion embedded in slurry, which will lead to bad taking off and embedding capacity of lithium-ion embedded in slurry and it will further have impact on slurry conductivity and cycle performance of lithium battery. What's more, if it needs to add dispersing agent to conductive agent to increase usage quantity of conductive fiber transition substance, then dispersing agent will reduce the content of active substance in slurry, which will further lower energy density of lithium battery, the use of dispersing agent will increase side reaction of lithium battery and it will further affect the use safety of lithium battery.

Besides, if tubular conductive substance and conductive spherical node substance are for compound use, tubular conductive substance and conductive spherical node substance are used with little quantity and tubular conductive substance can't form tight three-dimensional structure to have full contact with conductive spherical node substance, which will lead to bad conductivity of conductive agent. It is important to make it clear that if conductive fiber transition substance and conductive spherical node substance are for compound use, then conductivity of conductive agent is worse than the conductivity of compound use of tubular conductive substance and conductive spherical node substance, which leads to bad conductivity of conductive agent. In an implemented case, Ternary composite conductive adhesive includes following quantity groups: binders 4-8 shares; solvent 85-96 shares; conductive spherical node substance 0.5-3 shares; conductive fiber transition substance 0.1-2 shares; tubular conductive substance 0.03-1.5 shares. It is understandable that lithium battery slurry is formed directly after the applied Ternary composite conductive adhesive and active substances are mixed evenly. In the applied Ternary composite conductive adhesive, as tubular conductive substance has good electron transition capacity which can help to speed up transition of electrons. While the outer shape of conductive spherical node substance is like a ball, namely conductive spherical node substance is conductive substance with spherical structure which adds distribution density degree of conductive substance, providing more electron transition contact points for lithium-ion in slurry containing Ternary composite conductive adhesive. However, the outer shape of conductive fiber transition substance is like fiber, namely conductive fiber transition substance is conductive substance with fiber structure, and conductive substance with fiber structure is soft and it can connect tubular conductive substance and conductive spherical node substance. When the total quantity of conductive agent is reduced, even if the quantity of conductive spherical node substance is 0.5-3 shares; the quantity of conductive fiber transition substance is 0.1-2 shares and the quantity of tubular conductive substance is 0.03-1.5 shares, while slurry that contains Ternary composite conductive adhesive takes account of 0.63%-6.5%, quick transition of electrons of conductive agent and and taking off and embedding capacity of lithium-ion embedded in slurry containing Ternary composite conductive adhesive can be achieved. Furthermore, less usage of conductive agent will increase the content of active substances in slurry containing Ternary composite conductive adhesive, which will improve energy density of lithium battery and high power charge and discharge performance.

In an implemented case, binder is at least one of following items, polyvinylidene fluoride, polyacrylate and butylbenzene rubber. It is understandable that polyvinylidene fluoride, polyacrylate and butylbenzene rubber all have good adhesiveness, which can effectively improve viscosity of solvent and avoid sedimentation after conductive agent is dispersed in solvent and dispersity issue of conductive agent, which can effectively increase dispersing stability of conductive agent.

In an implemented case, binders include butylbenzene rubber and polyacrylate. It is understandable that butylbenzene rubber can effectively improve performance in high temperature resistance and aging resistance of TERNARY composite conductive agent, and the chain of butylbenzene rubber is long, which is more beneficial to improving dispersing stability of conductive agent of Ternary composite conductive adhesive, but the impedance of butylbenzene rubber is high, thus adding acrylate with low impedance to mix with butylbenzene rubber, reducing the increase of impedance of Ternary composite conductive adhesive after binder is added, which will lead to conductivity of Ternary composite conductive adhesive and enhance dispersing stability of conductive agent of Ternary composite conductive adhesive. In addition, acrylate can improve low temperature resistance of conductive agent of Ternary composite conductive adhesive.

In an implemented case, the mass ratio of butylbenzene rubber and polyacrylate is 0.3-0.65, it can reduce the increase of impedance of Ternary composite conductive adhesive after binder is added, which leads to the decrease of conductivity performance of Ternary composite conductive adhesive, and improves dispersing stability of conductive agent of Ternary composite conductive adhesive.

In an implemented case, the solvent is organic solvent or water. It is understandable that organic solvent or water with binder can assure dispersing stability of conductive agent evenly.

In an implemented case, all mentioned solvents are N-Methyl pyrrolidone and can make sure dispersing stability of conductive agent well.

In an implemented case, conductive spherical node substance is spherical carbon black. It is understandable that spherical carbon black has relatively big specific surface area which is beneficial to absorption of electrolyte and the use of spherical carbon black adds distribution density degree of conductive substances in unit composite conductive adhesive, provides more contact points for electron transition for lithium-ion embedded in slurry containing Ternary composite conductive adhesive, improves capacity of taking off and embedding of lithium-ion embedded in slurry containing Ternary composite conductive adhesive, which will further increase cycle performance of lithium battery and charge and discharge rate performance.

In an implemented case, conductive spherical node substance is at least of one of categories from furnace black, acetylene black and Ketjen black. It is understandable that furnace black, acetylene black and Ketjen black can provide more contact points for electron conductivity for lithium-ion in slurry containing Ternary composite conductive adhesive, which can improve the taking off and embedding capacity of lithium-ion embedded in slurry containing Ternary composite conductive adhesive, and it will further enhance cycle performance of lithium battery and high rate discharge performance.

In an implemented case, conductive fiber transition substance is carbon fiber. It is understandable that the fiber structure of carbon fiber can help to form conduction network and connect tubular conductive substance and conductive spherical node substance to form a system in which electron can be transited and lithium-ion can take off and embed quickly, which can effectively increase cycle performance of lithium battery and high rate discharge performance.

In an implemented case, tubular conductive substance is carbon nano tube. It can be understood that it's hallow inside carbon nano tube and it's long column shape which leads to good conductivity capacity and conduction speed for ternary composite conductive adhesive and can improve tenacity of ternary composite materials, which can improve desquamation strength of slurry in lithium battery and improve cycle performance of battery.

In an implemented case, tubular conductive substance is at least one of these including single-walled carbon nanotube and multi-walled carbon nanotube. It can be understood that both single-walled carbon nanotube and multi-walled carbon nanotube can make Ternary composite conductive adhesive have good conductivity capacity and conduction speed and can improve resilience of ternary composite materials, and these will improve desquamation strength of slurry in lithium battery and boost cycle performance of battery.

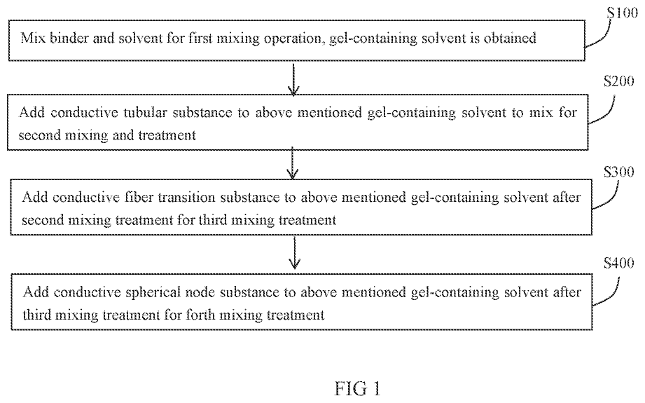

Please refer to FIG. 1, the preparation method of ternary composite conductive adhesive by one implementation way includes following steps:

S100. Combine binder and solvent for first mixing operation, and gel-containing solvent is obtained. It can be understood that if conductive agent and solvent are first dispersed evenly, and then add binder to conductive agent to increase denseness and dispersity, it should mix solvent at high speed before adding binder to solvent to make sure there will be no sedimentation originating from tubular conductive substance, conductive spherical node substance and conductive fiber transition substance, and add binder to solvent containing conductive agent which has certain absorption of binder, which makes it difficult for binder to disperse and reduce the dispersing homogeneity of ternary composite conductive adhesive. therefore, it will first mix binder and solvent in the applied ternary composite conductive adhesive, which will decrease the difficulty of dispersity of adhesives and improve dispersing homogeneity of binder, and reduce dispersing strength during process of dispersity of conductive agent, in other words, conductive agent can stop high speed mixing after a stable system is formed in solvent, which can avoid the situation that solvent needs to be mixed with high speed before binder is not added to solvent to make sure there is no sedimentation originating from tubular conductive substance, conductive spherical node substance and conductive fiber transition substance, which will help to reduce preparation costs of ternary composite conductive adhesive.

S200. Add tubular conductive substance to gel-containing solvent for second mixing and treatment. It can be understood that as tubular conductive substance is tubular lineal structure substance, it is easier than conductive spherical node substance and conductive fiber transition substance to gather. Therefore, it will add conductive spherical node substance to solvent containing adhesive to disperse and primarily form a new shape three-dimensional structure. It can also be understood that it will add conductive fiber transition substance to gel-containing solvent, conductive fiber transition substance will form three-dimensional net structure, because there is interruption between molecules, so it's difficult for tubular conductive substance to come into three-dimensional net structure formed by conductive fiber transition substance, which reduces dispersing homogeneity of conductive substance and conductivity performance of Ternary composite conductive adhesive.

S300. Add conductive fiber transition substance to gel-containing solvent after secondary mixing and treatment for third mixing and treatment. It can be understood that as conductive fiber transition substance is like fiber structure, and conductive substance with fiber structure is relatively soft, when adding conductive fiber transition substance to gel-containing solvent which contains tubular conductive substance, conductive fiber transition substance can come into three-dimensional net structure formed by tubular conductive substance and further improve three-dimensional net structure, and connecting tightness of three-dimensional net structure is enhanced and conductivity of Ternary composite conductive adhesive will also be improved.

S400. Add conductive spherical node substance to solvent after third mixing and treatment for forth mixing and treatment. It can be understood that the dispersing difficulty of conductive spherical node substance is lower than that of tubular conductive substance and conductive fiber transition substance. Therefore, it will add conductive spherical node substance to gel-containing solvent which contains tubular conductive substance and conductive fiber transition substance, which is beneficial for conductive spherical node substance to fill three-dimensional net structure after improvement, which can effectively improve distribution denseness degree of conductive agent and it will help enhance conductivity of Ternary composite conductive adhesive.

For above-mentioned preparation method of Ternary composite conductive adhesive, it will combine and mix binder and solvent first, which can reduce dispersing difficulty of adhesion agent and increase dispersing homogeneity of binder and decrease dispersing strength during process of dispersion of conductive agent. That means mixing at high speed can be stopped after conductive agent form a stable system in solvent, it will avoid solvent mixing at high speed before binder is not added to solvent to make sure there is no sedimentation originating from tubular conductive substance, conductive spherical node substance and conductive fiber transition substance and preparation cost of Ternary composite conductive adhesive will also be reduced. In addition, it will add tubular conductive substance to gel-containing solvent for dispersion to primarily form net shape three-dimensional structure, and then add conductive fiber transition substance to tubular conductive substance's gel-containing solvent to improve three-dimensional net shape structure, connecting tightness of three-dimensional net structure is enhanced which is beneficial to filling of three-dimensional net shape structure after improvement by conductive spherical node substance and it can boost distribution denseness of conductive agent, which will further improve Ternary composite conductive adhesive.

In an implemented case, when mixing speed is higher than 350 r/min, it will mix binder and solvent for first operation to make sure homogeneity of binder and solvent.

In an implemented case, when mixing speed is higher than 350 r/min, add tubular conductive substance to gel-containing solvent for secondary mixing and treatment, making sure mixing homogeneity of tubular conductive substance and gel-containing solvent.

In an implemented case, when mixing speed is higher than 350 r/min, add conductive fiber transition substance to gel-containing solvent after secondary mixing and treatment for third mixing and treatment to make sure mixing homogeneity of conductive fiber transition substance and gel-containing solvent.

In an implemented case, when mixing speed is higher than 350 r/min, add conductive spherical node substance to gel-containing solvent after third mixing and treatment for forth mixing and treatment to make sure mixing homogeneity of conductive spherical node substance and gel-containing solvent.

Slurry of one implementation way includes mixed active substances and Ternary composite conductive adhesive made with Ternary composite conductive adhesive preparation method used for above-mentioned any cases. In the implemented case, steps for preparation method of Ternary composite conductive adhesive are shown as below: Mix binder and solvent for first mixing operation, and gel-containing solvent will come out; Add tubular conductive substance to gel-containing solvent for second mixing and treatment; Add conductive fiber transition substance to gel-containing solvent after second mixing and treatment for third mixing and treatment; Add conductive spherical node substance to gel-containing solvent after third mixing and treatment for forth mixing and treatment.

In above-mentioned slurry, ternary composite conductive adhesive is made with preparation method of Ternary composite conductive adhesive. The conductive substance with tubular structure in Ternary composite conductive adhesive has good electron conduction capacity, and can speed up conduction of electrons, and make compound use for tubular conductive substance, conductive spherical node substance and conductive fiber transition substance, it will not only improve slurry performance from tubular conductive substance, conductive spherical node substance and conductive fiber transition substance respectively and they can improve slurry performance as whole compound. Conductive spherical node substance adds distribution denseness degree of conductive substance, which provides more contact points for electron conduction for lithium-ion embedded in slurry. Conductive fiber transition substance is soft, and it can connect conductive substance with tubular structure and conductive spherical node substance, which can achieve quick electron conduction in slurry and improve taking off and embedding capacity of lithium-ion embedded in slurry. That means compound use by adopting conductive spherical node substance, conductive fiber transition substance and tubular conductive substance, which can effectively improve conductivity of slurry.

Battery with one implementation way includes slurry mentioned in any above implemented cases. In this case, slurry includes mixed active substance and Ternary composite conductive adhesive achieved by preparation method of Ternary composite conductive adhesive in any above implemented case. The steps for preparation method of ternary composite conductive adhesive are shown as below: Mix binder and solvent for first mixing operation, and gel-containing solvent will come out; Add tubular conductive substance to gel-containing solvent for second mixing and treatment; Add conductive fiber transition substance to gel-containing solvent after second mixing and treatment for third mixing and treatment; Add conductive spherical node substance to gel-containing solvent after third mixing and treatment for forth mixing and treatment.

For above batteries, slurry of ternary composite conductive adhesive made with preparation method of Ternary composite conductive adhesive is used. The use of conductive agent of Ternary composite conductive adhesive in slurry improves conduction performance of slurry and improve high rate discharge and cycle performance of batteries.

Compared with current technologies, this invention has at least following advantages: In the invented ternary composite conductive adhesive, the outer shape of tubular conductive substance is like tube, namely tubular conductive substance is conductive substance with tubular structure which has good electron conduction capacity and it can speed up electron conduction. However, if conductive substance with tubular structure is used at large quantity, then it's easy for conductive substance with tubular structure to gather, which will affect conductivity of lithium battery slurry and energy density of lithium battery; If the usage quantity of conductive substance with tubular structure is small, less contact points between electron conducted in slurry containing ternary composite conductive adhesive and lithium-ion embedded in slurry will reduce conductivity of slurry containing Ternary composite conductive adhesive, which will further make compound use for tubular conductive substance with conductive spherical node substance and conductive fiber transition substance, and it will make compound use of tubular conductive substance with conductive spherical node substance and conductive fiber transition substance to reduce the quantity of usage of conductive substance with tubular structure and increase contact points between conducted electrons in slurry containing Ternary composite conductive adhesive and lithium-ion embedded in slurry. The outer shape of conductive spherical node substance is like a ball, which means conductive spherical node substance is conductive substance with spherical structure, which can add distribution denseness degree of conductive substance and provide more contact points for electron conduction for lithium-ion in slurry containing Ternary composite conductive adhesive. The outer shape of conductive fiber transition substance is like fiber, namely conductive fiber transition substance is conductive substance with fiber structure which is soft, and can connect conductive substance with tubular structure and conductive spherical node substance, it will also help to achieve quick electron conduction in slurry containing ternary composite conductive adhesive and improve taking off and embedding capacity of lithium-ion embedded in slurry containing ternary composite conductive adhesive, which means adopting conductive spherical node substance, conductive fiber transition substance and tubular conductive substance for compound use and they can effectively improve conductivity of ternary composite conductive adhesive. In addition, adopting binder and solvent to disperse conductive agent. Solvent provides enough space of dispersion for conductive agent, and binder enhances denseness of solvent, which will avoid further sedimentation after conductive agent is dispersed in solvent and reduce the dispersion of conductive agent, which can improve dispersing stability of conductive agent.

Some implemented cases with details will be listed as below, if % is mentioned, it means it's calculated by percentages. It is important to note that following cases may not list out all situations that may happen, and materials used in following cases can be obtained from commercial channels if there is no special statement.

### Embodiment 1

Mix 4 kg Kynar with 85 kg water, mixing speed is 350 r/min;

Add 0.5 kg furnace black to mixed solvent with kynar and water, mixing speed is 350 r/min;

Add 0.1 kg carbon fiber to solvent with kynar and water for mixing, mixing speed is 350 r/min;

Add 0.03 kg single-walled carbon nanotube to mixed solvent with Kynar and water for mixing, mixing speed is 350 r/min, Ternary composite conductive adhesive can be achieved;

Measure 6 kg Ternary composite conductive adhesive and put it in a 10 L double planetary mixer cylinder, firstly add 3.5 kg lithium cobalt oxides for mixing, set revolution of 120 HZ, and self-rotation of 6,000 RPM for 60 minutes. Add 3.5 kg lithium cobalt oxides for mixing for second time, set revolution of 125 HZ, and self-rotation of 3700 RPM for 150 minutes. Then use No. 200 screen mesh to filter mixed LCO and Ternary composite conductive adhesive to coat cathode electrodes and make cathode electrodes;

Measure 4 kg Ternary composite conductive adhesive and put it in a 10 L double planetary mixer cylinder, add 3.8 kg man-made graphite to mix, set revolution of 125 HZ and self-rotation of 5,000 RPM for 180 minutes. Then use No. 200 screen mesh to filter mixed man-made graphite and Ternary composite conductive adhesive to coat anode electrodes and make anode electrodes;

Assembly cathode electrodes, anode electrodes, separator and electrolytes into battery, and make them into lithium battery after formation and capacity classification.

### Embodiment 2

Mix 6 kg polyacrylate and 90 kg N-Methyl pyrrolidone, mixing speed is 350 r/min;

Add 2 kg furnace black to mixed solvent of polyacrylate and N-Methyl pyrrolidone and mix them, mixing speed is 350 r/min;

Add 1 kg carbon fiber to mixed solvent of polyacrylate and N-Methyl pyrrolidone and mix them, mixing speed is 350 r/min;

Add 0.8 kg single-walled carbon nanotube to mixed solvent of polyacrylate and N-Methyl pyrrolidone and mix them, mixing speed is 350 r/min, Ternary composite conductive adhesive can be obtained;

Measure 6 kg Ternary composite conductive adhesive and put it in a 10 L double planetary mixer cylinder, firstly add 3.5 kg lithium cobalt oxides for mixing, set revolution of 120 HZ, and self-rotation of 3,700 RPM for 60 minutes. Add 3.5 kg lithium cobalt oxides for mixing for second time, set revolution of 120 HZ, and self-rotation of 6,000 RPM for 150 minutes. Then use No. 200 screen mesh to filter mixed LCO and Ternary composite conductive adhesive to coat cathode electrodes and make cathode electrodes;

Measure 4 kg Ternary composite conductive adhesive and put it in a 10 L double planetary mixer cylinder, add 3.8 kg man-made graphite to mix, set revolution of 125 HZ and self-rotation of 5000 RPM for 180 minutes. Then use No. 200 screen mesh to filter mixed man-made graphite and Ternary composite conductive adhesive to coat anode electrodes and make anode electrodes;

Assembly cathode electrodes, anode electrodes, separator and electrolytes into battery, and make them into lithium battery after formation and capacity classification.

### Implemented Embodiment 3

Mix 8 kg butadiene styrene rubber with 96 kg water, mixing speed is 350 r/min;

Add 3 kg furnace black to mixed solvent of butadiene styrene rubber and water and mix them, mixing speed is 350 r/min;

Add 2 kg carbon fiber to mixed solvent of butadiene styrene rubber and water and mix them, mixing speed is 350 r/min;

Add 1.5 kg single-walled carbon nanotube to mixed solvent of butadiene styrene rubber and water and mix them, mixing speed is 350 r/min, Ternary composite conductive adhesive can be obtained;

Measure 6 kg Ternary composite conductive adhesive and put it in a 10 L double planetary mixer cylinder, firstly add 3.5 kg lithium cobalt oxides for mixing, set revolution of 125 HZ, and self-rotation of 3,700 RPM for 60 minutes. Add 3.5 kg lithium cobalt oxides for mixing for second time, set revolution of 120 HZ, and self-rotation of 6,000 RPM for 150 minutes. Then use No. 200 screen mesh to filter mixed LCO and Ternary composite conductive adhesive to coat cathode electrodes and make cathode electrodes;

Measure 4 kg Ternary composite conductive adhesive and put it in a 10 L double planetary mixer cylinder, add 3.8 kg man-made graphite to mix, set revolution of 125 HZ and self-rotation of 5,000 RPM for 180 minutes. Then use No. 200 screen mesh to filter mixed man-made graphite and Ternary composite conductive adhesive to coat anode electrodes and make anode electrodes;

Assembly cathode electrodes, anode electrodes, separator and electrolytes into battery, and make them into lithium battery after formation and capacity classification.

### Embodiment 4

Use solid content of 4.55% wt Ternary composite conductive adhesive to make cathode;

Mix 1.05 kg polyacrylate, 0.45 kg butadiene styrene rubber and 95.5 kg N-Methyl pyrrolidone, mixing speed is 350 r/min;

Add 2.5 kg furnace black to polyacrylate, butadiene styrene rubber and N-Methyl pyrrolidone and mix them, mixing speed is 350 r/min;

Add 0.5 kg carbon fiber to mixed solvent of polyacrylate, butadiene styrene rubber and N-Methyl pyrrolidone and mix them, mixing speed is 350 r/min;

Add 0.05 kg single-walled carbon nanotube to mixed solvent of polyacrylate, butadiene styrene rubber and N-Methyl pyrrolidone and mix them, mixing speed is 350 r/min and Ternary composite conductive adhesive can be obtained;

Use solid content of 5% wt Ternary composite conductive adhesive to make anode;

Mix 1.5 kg polyacrylate, 15 kg butadiene styrene rubber and 95.5 kg water, mixing speed is 350 r/min;

Add 2 kg furnace black to polyacrylate, butadiene styrene rubber and water and mix them, mixing speed is 350 r/min;

Add 0.47 kg carbon fiber to mixed solvent of polyacrylate, butadiene styrene rubber and water and mix them, mixing speed is 350 r/min;

Add 0.03 kg single-walled carbon nanotube to mixed solvent of polyacrylate, butadiene styrene rubber and water and mix them, mixing speed is 350 r/min and Ternary composite conductive adhesive can be obtained;

Measure 6 kg Ternary composite conductive adhesive with solid content of 4.55% wt and put it in a 10 L double planetary mixer cylinder, firstly add 3.5 kg lithium cobalt oxides for mixing, set revolution of 125 HZ, and self-rotation of 6,000 RPM for 60 minutes. Add 3.5 kg lithium cobalt oxides for mixing for second time, set revolution of 120 HZ, and self-rotation of 6,000 RPM for 150 minutes. Then use No. 200 screen mesh to filter mixed LCO and Ternary composite conductive adhesive to coat cathode electrodes and make cathode electrodes;

Measure 4 kg Ternary composite conductive adhesive with solid content of 5% wt and put it in a 10 L double planetary mixer cylinder, add 3.8 kg man-made graphite to mix, set revolution of 125 HZ and self-rotation of 5,000 RPM for 180 minutes. Then use No. 200 screen mesh to filter mixed man-made graphite and Ternary composite conductive adhesive to coat anode electrodes and make anode electrodes;

Assembly cathode electrodes, anode electrodes, separator and electrolytes into battery, and make them into lithium battery after formation and capacity classification.

Performance test as below for lithium battery in embodiments 1-4:

Table 1 is discharge capacity and capacity maintenance quantity at different discharge rate for lithium batteries in embodiments 1-4:

| | | Discharge rate | | | | | | | | |
|---|---|---|---|---|---|---|---|---|---|---|
| Data | | 1C | 30C | 40C | 50C | 60C | 70C | 80C | 90C | 100C |
| embodiment | Discharge | 1309 | 1304 | 1301 | 1296 | 1292 | 1285 | 1250 | 1216 | 1101 |
| 1 | capacity | | | | | | | | | |
| | (mAh) | | | | | | | | | |
| | capacity | — | 99.5 | 99.4 | 99.1 | 98.4 | 98.1 | 96.9 | 92.2 | 80.3 |
| | maintenance | | | | | | | | | |
| | rate % | | | | | | | | | |
| embodiment | Discharge | 1309 | 1305 | 1303 | 1300 | 1296 | 1287 | 1254 | 1220 | 1106 |
| 2 | capacity | | | | | | | | | |
| | (mAh) | | | | | | | | | |
| | capacity | — | 99.7 | 99.6 | 99.4 | 98.8 | 98.5 | 97.4 | 93.6 | 82.2 |
| | maintenance | | | | | | | | | |
| | rate % | | | | | | | | | |
| embodiment | Discharge | 1309 | 1302 | 1299 | 1295 | 1290 | 1281 | 1243 | 1220 | 1095 |
| 3 | capacity | | | | | | | | | |
| | (mAh) | | | | | | | | | |
| | capacity | — | 99.6 | 99.5 | 99.2 | 98.5 | 98.0 | 96.7 | 92.4 | 80.2 |
| | maintenance | | | | | | | | | |
| | rate % | | | | | | | | | |
| embodiment | Discharge | 1309 | 1308 | 1306 | 1304 | 1301 | 1296 | 1282 | 1233 | 1115 |
| 4 | capacity | | | | | | | | | |
| | (mAh) | | | | | | | | | |
| | capacity | — | 99.9 | 99.8 | 99.6 | 99.4 | 99.0 | 97.9 | 94.2 | 85.2 |
| | maintenance | | | | | | | | | |
| | rate % | | | | | | | | | |

Table 1 is discharge capacity and capacity maintenance quantity at different discharge rate for lithium batteries in case 1-4:

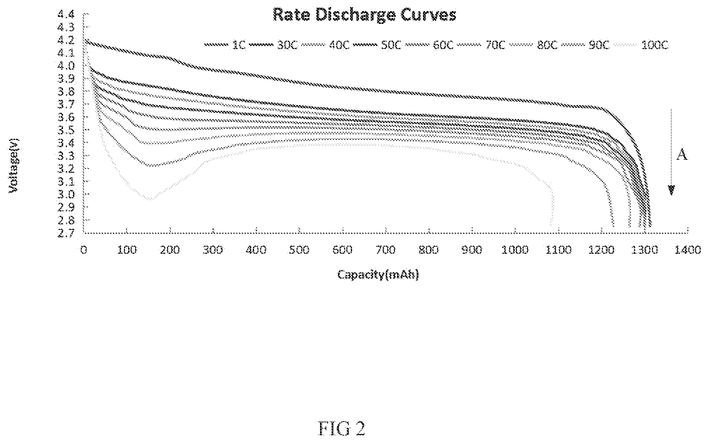

FIG. 2 is a discharge curve line at different discharge rate for lithium batteries in case 4. It shows that on the direction of A, the discharge rate are respectively 1 C, 30 C, 40 C, 50 C, 60 C, 70 C, 80 C, 90 C and 100 C.

It can be observed from Table 1 and FIG. 2 that all lithium batteries in case 1-4 support 100 C rate discharge and they have good rate discharge performance, especially the lithium battery in case 4 has best high rate discharge performance.

Each technical characteristics of all mentioned cases above can be casually combined. It has not described every technical characteristics for all possible combinations from cases above in order to make it brief. However, if there is no contrary between these technical combinations, then all shall be deemed as scope of this invention prescribes.

Cases listed above only express some implementation methods of this invention, their descriptions are specific and detailed, but it shall not be deemed as limits to patent scope of the invention. It is necessary to point out that ordinary technicians in the field can make some transformations and improvements without separating from this invention thinking, all these belong to protection scope of this invention. Therefore, the protection scope of this invention shall refer to requirements in the attached claims.

1. A ternary composite conductive adhesive, including following items:
binder;
solvent; and
conductive agent, wherein the conductive agent includes conductive spherical node substance, conductive fiber transition substance and tubular conductive substance.

2. The ternary composite conductive adhesive according to claim 1, wherein the binder is at least one of polyvinylidene fluoride, polyacrylate and butadiene styrene rubber.

3. The ternary composite conductive adhesive according to claim 1, wherein the binder includes butadiene styrene rubber and polyacrylate.

4. The ternary composite conductive adhesive described in claim 1, wherein the binder includes butadiene styrene rubber and polyacrylate the mass ratio of which is 0.3-0.65.

5. The ternary composite conductive adhesive described in claim 1, wherein the solvent is organic solvent or water.

6. The ternary composite conductive adhesive described in claim 1, wherein the conductive spherical node substance is spherical carbon black.

7. The ternary composite conductive adhesive described in claim 1, wherein the conductive spherical node substance is at least one of furnace black, acetylene black and Ketjen black.

8. The ternary composite conductive adhesive described in claim 1, wherein the conductive fiber transition substance is carbon fiber.

9. The ternary composite conductive adhesive described in claim 1, its characteristic is that the tubular conductive substance is carbon nanotube.

10. The ternary composite conductive adhesive according to claim 1, wherein the tubular conductive substance is at least one of single-walled carbon nanotube and multi-walled carbon nanotube.

11. The ternary composite conductive adhesive according to claim 1, wherein the ternary composite conductive adhesive includes the following items in parts by mass:

| | |
|---|---|
| binder | 4-8 shares; |
| solvent | 85-96 shares; |
| conductive spherical node substance | 0.5-3 shares |
| conductive fiber transition substance | 0.1-2 shares; and |
| tubular conductive substance | 0.03-1.5 shares. |

12. The ternary composite conductive adhesive according to claim 11, wherein the binder is at least one of polyvinylidene fluoride, polyacrylate, butylbenzene rubber.

13. The ternary composite conductive adhesive according to claim 11, wherein the binder includes butylbenzene rubber and polyacrylate.

14. The ternary composite conductive adhesive according to claim 11, wherein the binder includes butylbenzene rubber and polyacrylate with mass ratio of 0.3-0.65.

15. The ternary composite conductive adhesive according to claim 11, wherein the solvent is organic solvent or water.

16. The ternary composite conductive adhesive according to claim 11, wherein the conductive spherical node substance is spherical carbon black.

17. The ternary composite conductive adhesive according to claim 11, wherein the conductive spherical node substance is at least one of furnace black, acetylene black and Ketjen black.

18. The ternary composite conductive adhesive according to claim 11, wherein the conductive fiber transition substance is carbon fiber.

19. The ternary composite conductive adhesive according to claim 11, wherein the tubular conductive substance is carbon nanotube.

20. The ternary composite conductive adhesive according to claim 11, wherein the tubular conductive substance is at least one of single-walled carbon nanotube and multi-walled carbon nanotube.

21. A preparation method of the ternary composite conductive adhesive according to claim 1, the preparation method comprising the following steps:
performing a first mixing operation on binder and solvent so as to obtain a gel-containing solvent;
adding a tubular conductive substance to the gel-containing solvent and perform a second mixing operation;
adding a conductive fiber transition substance to the gel-containing solvent which has been subjected to the second mixing operation and perform a third mixing operation; and
adding a conductive spherical node substance to the gel-containing solvent which has been subjected to the third mixing operation and perform a fourth mixing operation.

22. The preparation method of ternary composite conductive adhesive according to claim 21, wherein the first mixing operation is performed with a mixing speed higher than 350 r/min.

23. According to preparation method of ternary composite conductive adhesive according to claim 21, wherein the second mixing operation is performed with a mixing speed higher than 350 r/min.

24. According to preparation method of ternary composite conductive adhesive according to claim 23, wherein adding conductive fiber transition substance to described gel-containing solvent after second mixing and treatment for third mixing and treatment when mixing speed is higher than 350 r/min.

25. According to preparation method of ternary composite conductive adhesive according to claim 24, wherein adding conductive spherical node substance to described gel-containing solvent after third mixing and treatment for forth mixing and treatment when mixing speed is higher than 350 r/min.

26. A slurry, including mixed active substance and the composite conductive adhesive obtained by the preparation method according to claim 21.

27. A battery includes the slurry according to claim 26.

28. The battery according to claim 27, wherein a preparation method for the battery includes following steps:
mixing 4 kg polyvinylidene fluoride and 85 kg water at a stirring speed of 350 r/min;
adding 0.5 kg furnace black to a mixed solvent of polyvinylidene fluoride and described water and mix them at a stirring speed of 350 r/min;
adding 0.1 kg carbon fiber to mixed solvent of polyvinylidene fluoride and described water, mixing speed is 350 r/min;
adding 0.03 kg single-walled carbon nanotube to mixed solvent of described polyvinylidene fluoride and described water, mixing speed is 350 r/min and Ternary composite conductive adhesive is obtained;
measuring 6 kg ternary composite conductive adhesive and putting it in a 10 L double planetary mixer cylinder, firstly adding 3.5 kg lithium cobalt oxides for mixing, setting revolution of 125 HZ, and self-rotation of 3,700 RPM for 60 minutes; adding 3.5 kg lithium cobalt oxides for mixing for second time, setting revolution of 120 HZ, and self-rotation of 6,000 RPM for 150 minutes; and then using No. 200 screen mesh to filter mixed lithium cobalt oxides and ternary composite conductive adhesive to coat cathode electrodes and make cathode electrodes;
measuring 4 kg ternary composite conductive adhesive and put it in a 10 L double planetary mixer cylinder, add 3.8 kg man-made graphite to mix, setting revolution of 125 HZ and self-rotation of 5,000 RPM for 180 minutes, then using No. 200 screen mesh to filter mixed man-made graphite and the ternary composite conductive adhesive to coat anode electrodes and make anode electrodes; and
assembling the cathode electrodes, the anode electrodes, separators and electrolytes into battery, and making battery after formation and capacity classification.

29. The battery according to claim 27, wherein a preparation method for the battery includes following steps:
mixing 6 kg polyacrylate with 90 kg N-Methyl pyrrolidone, mixing speed is 350 r/min;
adding 2 kg furnace black to mixed solvent of polyacrylate with N-Methyl pyrrolidone for mixing, mixing speed is 350 r/min;
adding 1 kg carbon fiber to mixed solvent of described polyacrylate and N-Methyl pyrrolidone for mixing, and mixing speed is 350 r/min; and
adding 0.8 kg single-walled carbon nanotube to mixed solvent of described polyacrylate and N-Methyl pyrrolidone for mixing, and mixing speed is 350 r/min and ternary composite conductive adhesive is obtained;
measuring 6 kg Ternary composite conductive adhesive and putting it in a 10 L double planetary mixer cylinder, firstly add 3.5 kg lithium cobalt oxides for mixing, setting revolution of 125 HZ, and self-rotation of 3,700 RPM for 60 minutes. Add 3.5 kg lithium cobalt oxides for mixing for second time, setting revolution of 120 HZ, and self-rotation of 6,000 RPM for 150 minutes, then using No. 200 screen mesh to filter mixed lithium cobalt oxides and Ternary composite conductive adhesive to coat cathode electrodes and make cathode electrodes;
measure 4 kg ternary composite conductive adhesive and putting it in a 10 L double planetary mixer cylinder, add 3.8 kg man-made graphite to mix, setting revolution of 125 HZ and self-rotation of 5,000 RPM for 180 minutes, then using No. 200 screen mesh to filter mixed man-made graphite and the ternary composite conductive adhesive to coat anode electrodes and make anode electrodes; and
assembling the cathode electrodes, the anode electrodes, separators and electrolytes into battery, and make battery after formation and capacity classification.

30. The battery according to claim 27, wherein a preparation method for the battery includes the following steps:
mixing 8 kg butylbenzene rubber with 96 kg water, mixing speed is 350 r/min;
adding 3 kg furnace black to mixed solvent of butylbenzene rubber with water, mixing speed is 350 r/min;
adding 2 kg carbon fiber to mixed solvent of described butylbenzene rubber with water for mixing, and mixing speed is 350 r/min;
adding 1.5 kg single-walled carbon nanotube to mixed solvent of described butylbenzene rubber with water for mixing, and mixing speed is 350 r/min and Ternary composite conductive adhesive is obtained;
measuring 6 kg ternary composite conductive adhesive and put it in a 10 L double planetary mixer cylinder, firstly add 3.5 kg lithium cobalt oxides for mixing, set revolution of 125 HZ, and self-rotation of 3,700 RPM for 60 minutes, adding 3.5 kg lithium cobalt oxides for mixing for second time, set revolution of 120 HZ, and self-rotation of 6,000 RPM for 150 minutes, then using No. 200 screen mesh to filter mixed lithium cobalt oxides and ternary composite conductive adhesive to coat cathode electrodes and make cathode electrodes;
measuring 4 kg Ternary composite conductive adhesive and putting it in a 10 L double planetary mixer cylinder, add 3.8 kg man-made graphite to mix, setting revolution of 125 HZ and self-rotation of 5,000 RPM for 180 minutes, using No. 200 screen mesh to filter mixed man-made graphite and the ternary composite conductive adhesive to coat anode electrodes and make anode electrodes; and
assembling the cathode electrodes, the anode electrodes, separators and electrolytes into battery, and make battery after formation and capacity classification.

31. The battery according to claim 27, wherein a preparation method for the battery includes the following steps:
using ternary composite conductive adhesive with solid content of 4.55% wt for making cathode:
mixing 1.05 kg polyacrylate, 045 kg butylbenzene rubber and 95.5 kg N-Methyl pyrrolidone and mixing speed is 350 r/min
adding 2.5 kg furnace black to mixed solvent of above-mentioned polyacrylate, butylbenzene rubber and water for mixing, mixing speed is 350 r/min;
adding 0.5 kg carbon fiber to above-mentioned polyacrylate, butylbenzene rubber and water for mixing, mixing speed is 350 r/min;
adding 0.5 kg single-walled carbon nanotube to above-mentioned polyacrylate, butylbenzene rubber and water for mixing, mixing speed is 350 r/min and Ternary composite conductive adhesive is obtained;
using ternary composite conductive adhesive with solid content of 5% wt for making anode:
mixing 1.5 kg polyacrylate and 1 kg butylbenzene rubber and 95 kg water for mixing, and mixing speed is 350 r/min;
adding 2 kg furnace black to mixed solvent of described polyacrylate, butylbenzene rubber and water, and mixing speed is 350 r/min;
adding 0.47 kg carbon fiber to mixed solvent of described polyacrylate, butylbenzene rubber and water, and mixing speed is 350 r/min;
adding 0.03 kg single-walled carbon nanotube to mixed solvent of polyacrylate, butylbenzene rubber and water, and mixing speed is 350 r/min and ternary composite conductive adhesive is obtained;
measuring 6 kg ternary composite conductive adhesive with solid content of 4.55% and putting it in a 10 L double planetary mixer cylinder, firstly adding 3.5 kg lithium cobalt oxides for mixing, setting revolution of 125 HZ, and self-rotation of 3,700 RPM for 60 minutes; adding 3.5 kg lithium cobalt oxides for mixing for second time, setting revolution of 120 HZ, and self-rotation of 6,000 RPM for 150 minutes, then using No. 200 screen mesh to filter mixed lithium cobalt oxides and ternary composite conductive adhesive to coat cathode electrodes and make cathode electrodes;
measuring 4 kg ternary composite conductive adhesive with solid content of 5% and putting it in a 10 L double planetary mixer cylinder, adding 3.8 kg man-made graphite to mix, setting revolution of 125 HZ and self-rotation of 5,000 RPM for 180 minutes, then using No. 200 screen mesh to filter mixed man-made graphite and the ternary composite conductive adhesive to coat anode electrodes and make anode electrodes; and
assembling the cathode electrodes, the anode electrodes, separators and electrolytes into battery, and make battery after formation and capacity classification.
